(19) United States
(12) Patent Application Publication
(10) Pub. No.: US 2003/0148151 A1
(43) Pub. Date: Aug. 7, 2003

(54) Method for operating a fuel cell system, and associated fuel cell installation

(76) Inventor: Walter Preidel, Erlangen (DE)

Correspondence Address: LERNER AND GREENBERG, P.A., Post Office Box 2480, Hollywood, FL, 33022-2480, US

(21) Appl. No.: 10/368,156

(22) Filed: Feb. 18, 2003

Related U.S. Application Data
(63) Continuation of application No. PCT/DE01/02981, filed on Aug. 3, 2001.

(30) Foreign Application Priority Data
Aug. 16, 2000 (DE) 100 40 088.4

(51) Int. Cl. H01M 8/04

(52) U.S. Cl. 429/13; 429/26; 429/22

(57) ABSTRACT

Methanol forms the fuel of the fuel cells and it is supplied to the system. An anode fluid including waste gases, such as carbon dioxide or the like, have to be led away after combustion. The carbon dioxide, which develops on the anode, is separated while it is hot from the anode fluid after leaving the anode of the fuel cell stack. The vaporous fuel separated together with the carbon dioxide is depleted in a counter-current flow using cold water. The cold water is recovered in the condenser of the cathode waste gas, and the resulting warmer water is admixed to the anode liquid. In the installation, a cooler with a CO₂ trap arranged downstream is provided at least for the anode fluid, and a unit for carrying out rectification provided with which fuel contained there is separated and returned into the fuel circuit.

### CROSS-REFERENCE TO RELATED APPLICATION

This application is a continuation of copending International Application No. PCT/DE01/02981, filed Aug. 3, 2001, which designated the United States and was not published in English.

### BACKGROUND OF THE INVENTION

### Field of the Invention

The invention relates to a method for operating an installation having at least one fuel cell, in which one or more fuel cell stacks, to which a fuel is fed and, after combustion in the fuel cell unit, is discharged as anode liquid. At the same time, off-gases such as carbon dioxide or the like are formed from individual fuel cell units. In addition, the invention also relates to a fuel cell installation which includes a fuel cell stack having at least one fuel cell with anode part and cathode part separated by a membrane. In the invention, the fuel is preferably, although not exclusively, methanol.

Fuel cells are operated with liquid or gaseous fuels. If the fuel cell operates with hydrogen, a hydrogen infrastructure or a reformer for generating the gaseous hydrogen from the liquid fuel is required. Examples of liquid fuels are gasoline or alcohol, such as ethanol or methanol. A DMFC (“direct methanol fuel cell”) operates directly with liquid methanol as fuel.

The system of a direct methanol fuel cell (DMFC) is described, for example, in U.S. Pat. No. 5,599,638. In addition to the major drawbacks of a power density which is too low for industrially viable DMFC systems and the excessively high permeabilities of the commercially available membrane with respect to methanol and water, the DMFC has a number of peculiarities which are inherent to the system and has to be taken into account in an appropriate way in the operating concept of the system. These characteristics are:

a) since the proton-conducting membranes which are currently commercially available require liquid water for the conduction mechanism, the pressure and temperature for the anode liquid has to be selected in such a way that the boiling point of the liquid is not exceeded. Because the pressure difference between anode and cathode must not exceed the mechanical load-bearing capacity of the membrane and, on account of a pressure gradient, in fact additional water and methanol is even carried from the anode to the cathode, the pressure difference between anode and cathode to be as low as possible. For operation with air, in addition to the oxygen required nitrogen also has to be compressed and fed to the cathode, and consequently energy is wasted depending on the pressure level. Even a downstream expander can only reduce this loss rather than eliminate it altogether.

b) the electrode reaction results in the formation of carbon dioxide on the anode side, and this has to be separated from the anode liquid in the form of a gas and leaves the system as an off-gas. In this way, however, the fuel methanol will also leave the system as vapor together with the carbon dioxide. Here, therefore, there is a leak which leads firstly to a reduction in the utilization of fuel and secondly to emissions to the environment.

c) additional water is required to maintain the anode circuit, since the anode reaction consumes water. Therefore, it is necessary to recover so much water from the cathode off-gas by condensation that the system does not lose water, which would mean having to refill with water as well as fuel.

Therefore, the operating concept has to be designed in such a way that sufficient water is recovered from the cathode off-gas.

International application WO 99/44250 A1, in connection with item a) above, discloses a system in which the temperature is controlled by way of the running power of the pump for the anode liquid, and therefore the pressure is set by way of the temperature and the corresponding power of the compressor/expander. Since, in the system described in that document, the fuel concentration is kept constant. The fuel losses in part-load operation are inevitably very high. The efficiency bonus of the DMFC in part-load operation compared to a reformer/H₂ PEM system consequently does not manifest itself. The carbon dioxide forms at the anode in accordance with item b) is admixed with the cathode off-gas and therefore dilutes the methanol in order to satisfy the requirements relating to emissions. To recover the water from the cathode off-gas, a cooler and water separator are also connected downstream of the expander, so that as much water as possible condenses out.

### SUMMARY OF THE INVENTION

It is accordingly an object of the invention to provide a method of operating a fuel cell system and a corresponding fuel cell installation, which overcomes the above-mentioned disadvantages of the heretofore-known devices and methods of this general type and which improve the operating concept for a direct methanol fuel cell that is operated with liquid fuel. The specific object is to describe an improved method and an improved installation for this purpose.

With the foregoing and other objects in view there is provided, in accordance with the invention, a method of operating a fuel cell system having one or more stacks each with at least one fuel cell unit having an anode and a cathode, the fuel cell unit receiving a fuel during operation and discharging an anode liquid and off-gases. The novel method comprises the following steps:

separating out carbon dioxide formed at the anode, substantially immediately after the carbon dioxide emerges from the fuel cell stack, from the anode liquid while the anode liquid is hot, and thereby also separating out a quantity of fuel in vapor form together with the carbon dioxide;

obtaining cold water in a condenser for a cathode off-gas;

conducting the cold water in counter-current to deplete the quantity of fuel in vapor form separated out together with the carbon dioxide and thereby forming heated water; and

admixing the heated water with the anode liquid.

With the above and other objects in view there is also provided, in accordance with the invention, a fuel cell installation for operation with a liquid fuel, comprising: a fuel cell stack having at least one fuel cell with an anode part, a cathode part, and a membrane separating the anode part from the cathode part;

a fuel tank connected for supplying the liquid fuel mixed with water to the fuel cell;

a cooler for cooling an anode liquid and a CO₂ separator for separating CO₂ out of the anode liquid connected downstream of the cooler; and

a rectification unit connected to the fuel cell for separating fuel off and returning the fuel into a fuel circuit of the fuel cell.

In other words, the invention provides an improved operating concept for a fuel cell. In the specific application for a direct methanol fuel cell (DMFC) with liquid methanol and fuel, the following points are primarily important:

The carbon dioxide which is formed at the anode is separated from the anode liquid while it is hot immediately after emerging from the anode. In this situation, the separation is most effective, since the solubility of the carbon dioxide is lowest on account of the high temperature.

The levels of methanol vapor separated off together with the carbon dioxide are reduced by passing the mixture in counter current with respect to the cold water which is obtained in the condenser for the cathode off-gas.

The water, which is now warmer, is once admixed with the anode liquid upstream of the methanol sensor.

The methanol concentration is not kept constant, but rather is admixed in the anode circuit by way of a pump as a function of the flow. This results in a high efficiency even in partial load operation.

The methanol losses via the membrane, caused by diffusion and/or electroosmosis, are recorded by measuring the carbon dioxide concentration in the cathode off-gas and are taken into account in the metering of methanol.

The volume of the anode liquid is kept as low as possible, so that the control can take place as quickly as possible. This reduces the losses, improves the efficiency in particular in the event of a load change, improves the dynamics of the system and also accelerates the heating to operating temperature.

The anode liquid is pumped round as quickly as possible, so that the supply of methanol is sufficient even at a low concentration. As a result, the carbon dioxide is quickly carried away from the catalyst layer.

There is no need for further cooling of the stack, since as the temperature rises the heat resulting from the heat of evaporation of the water which permeates in liquid form from the anode to the cathode and evaporates at the cathode is carried away and therefore the heat is carried out of the stack. Therefore, the cooler can comprise a condenser in which the heat of condensation is dissipated between the water or to an air flow.

Particularly the latter points represent a significant advantage for the system of the direct methanol fuel cell, because with this principle, by selecting the system pressure and the excess of air, it is possible to preselect the maximum temperature of the stack and thereby control the fuel cell system.

Other features which are considered as characteristic for the invention are set forth in the appended claims.

Although the invention is illustrated and described herein as embodied in a method for operating a fuel cell system, and associated fuel cell installation, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram illustrating the operating concept of a DMFC fuel cell; and

FIG. 2 is a block diagram showing a supplement to FIG. 1 on the cathode side using an expander.

### DESCRIPTION OF THE PREFERRED EMBODIMENTS

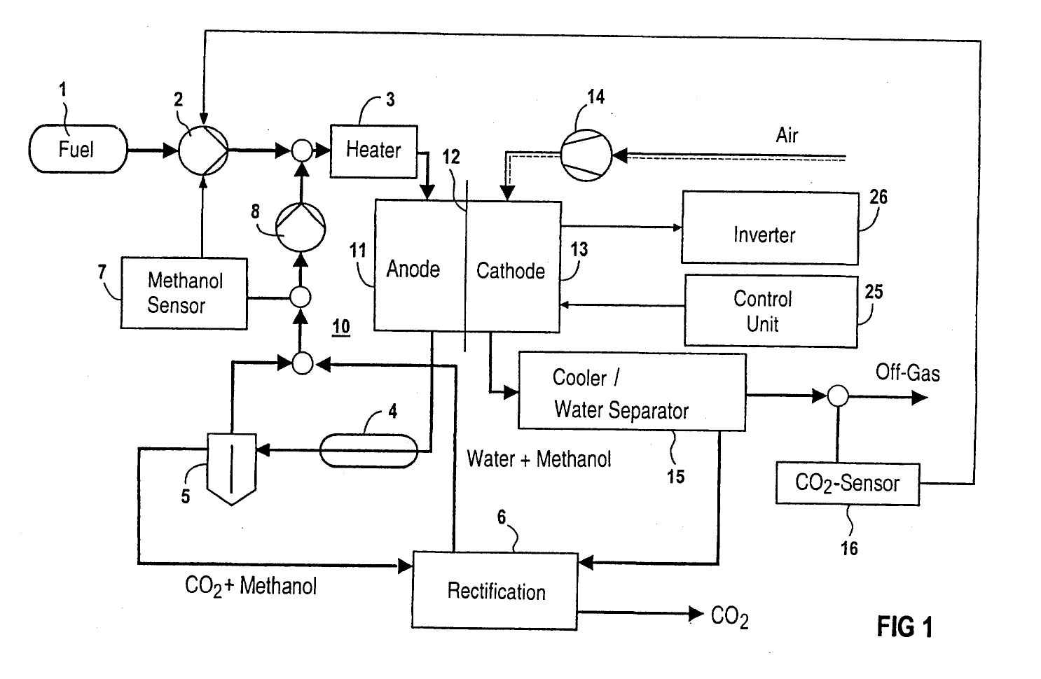

Referring now to the figures of the drawing in detail and first, particularly, to FIG. 1 thereof, there is shown an overview of a methanol fuel cell unit 10 with the associated operating units. In the context of this description, the liquid/gas circuits are of primary significance, although the electrical actuation is also important.

FIG. 1 shows a methanol tank 1 with a downstream metering pump 2 and a heating means 3, via which the liquid methanol as operating medium passes to the fuel cell unit 10. The fuel cell unit 10 is configured as a direct methanol fuel cell (DMFC) and it is primarily characterized by an anode 11, a membrane 12 and a cathode 13. The anode part is assigned a cooler 4, a CO₂ separator 5, a unit 6 for rectification, a methanol sensor 7, and a recirculation pump 8.

On the cathode side, there is provided a compressor 14 for air, a cooler or water separator 15 for the cathode liquid and a CO₂ sensor 16. Furthermore, to operate the installation, there is a unit 25 for controlling the fuel cell unit 10 and, if appropriate, an electrical inverter 26. The system disclosed herein allows the following operation, which brings significant improvements over the prior art: the carbon dioxide which forms at the anode 11, immediately after it emerges from the anode 11 from the fuel cell stack, is separated from the anode liquid while it is hot. This is where the separation is most effective, since the solubility of carbon dioxide is lowest on account of the high temperature prevailing here. The level of methanol vapor which has been separated off together with the carbon dioxide is reduced in the mixture by passing the methanol in counter current with respect to the cold water that is obtained in the cooler 16 or condenser of the cathode off-gas, which takes place in the unit 6 for rectification. The resulting warm water is admixed with the anode liquid again, specifically upstream of the methanol sensor 7. The methanol concentration is not kept constant, but rather is admixed to the anode circuit by way of the circulation pump 8 depending on the flow. This results in a high level of efficiency even in partial-load operation.

In the system described, methanol losses via the membrane 12 of the fuel cell unit 10, which are caused by diffusion and electroosmosis, are recorded by measuring the carbon dioxide concentration in the cathode off-gas with the sensor 16. The measurement is taken into account during the metering of methanol in the anode circuit. The volume of the anode liquid can be kept as low as possible, so that rapid control is provided. Therefore, losses are minimized and the efficiency is increased, in particular in the event of a load change. The dynamics of the overall system are improved compared to prior art installations, and the heating to operating temperature is also accelerated.

In the system illustrated in FIG. 1, the anode liquid can be pumped around quickly, with the result that the supply of methanol is sufficient even when the concentration is low. The disruptive carbon dioxide is as a result quickly carried away from the catalyst layer.

The system described with reference to FIG. 1 does not need additional cooling of the fuel cell stack, since as the temperature rises the current which permeates from the anode to the cathode evaporates at the cathode, and as a result the heat is carried out of the fuel cell stack.

Therefore, the cooler 15 may comprise a condenser as a result of the heat of condensation being dissipated to cooling water or to an air flow.

The defined temperature of the condensation of the water vapor in the cathode off-gas, in conjunction with the excess of air on the cathode side and the system pressure at the cathode, defines the quantity of water which has to be recovered for the system to operate. The reaction equation for the anode reaction, cathode reaction and the resulting overall reaction are as follows:

$$Anode \text{:} {CH}_{3} OH + {H}_{2} O \to 6 {H}^{+} + {CO}_{2} + 6 e$$

$$Cathode \text{:} 3 / 2 {O}_{2} + 6 {H}^{+} \to 3 {H}_{2} O$$

$$Overall \text{:} {CH}_{3} OH + 3 / {20}_{2} \to {CO}_{2} + 2 {H}_{2} O$$

Of the three water molecules which form at the cathode per molecule of methanol, one water molecule has to be condensed out in the cathode off-gas and returned to the anode liquid. The additional water which is conveyed to the cathode via the three water molecules is likewise condensed out by presetting the dew point of the condensation of the one molecule in the air on the cathode side, since its dew point temperature is higher, since it is additional water and therefore condenses out at a higher dew point. Therefore, using the vapor pressure curve of the water, it is possible, for a given quantity of air which corresponds to the stoichiometrically required quantity multiplied by the number λ (λ=1−10, preferably 1.5 to 2.5), to specify an associated temperature or a related pressure at which one of the three molecules of water condenses out. Under these operating conditions, the quantity of water in the fuel cell system is kept constant.

In FIG. 1, there is an electrical inverter 26. This inverter 26 is optional and is used to convert the DC voltage into AC voltage if required.

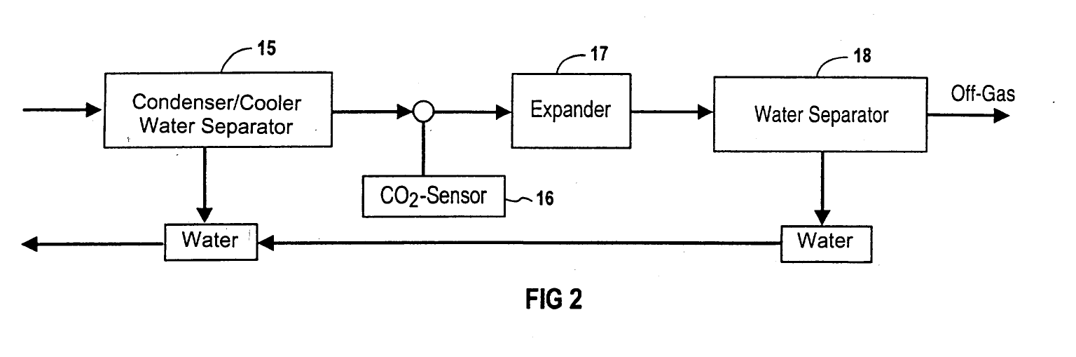

In FIG. 2, there is an additive expander 17 at the cathode outlet downstream of the condenser/cooler-water separator, in order to recover energy from the expansion. In this case, a further water separator 18 is arranged downstream of the expander 17 in order to recover the water which condenses out as a result of the further cooling of the outgoing air in the expander 17. The dew point is thereby reduced further. Since this is not absolutely necessary for the water budget, therefore, the size of the condenser/cooler 15 upstream of the expander can be reduced.

In FIG. 1, the heating unit 3 for the anode liquid is present in order to shorten the start-up time of the fuel cell, in particular temperatures ≦10° C. Heating of the anode liquid before it enters the anode of the fuel cell stack is not absolutely imperative, however.

Since the outgoing air has a high heat content because it is laden with water vapor, it is advantageous to heat the incoming air to operating temperature by way of the outgoing air in counter current using an additional heat exchanger. This reduces the temperature gradient in the stack, improves the efficiency of the installation and cools the outgoing air slightly, so that the size of the outgoing-air condenser/cooler can be reduced slightly.

If the anode liquid is pumped through the stack at a delivery rate which is as high and constant as possible, as executed in detail on the basis of FIG. 1, it is possible to estimate the methanol concentration of the liquid from the electric power or electric current of the pump, since the viscosity of the methanol/water mixture is dependent on the methanol content. Furthermore, the viscosity of the mixture is dependent on the temperature. At temperatures above 80° C, the effect is in any case very low. The electric current of the pump at a constant rotation speed, i.e. at a constant delivery, is then a measure of the methanol concentration at a constant temperature.

With the operating method described in detail and the associated installation, it is possible to considerably improve the operation of direct methanol fuel cells. The nozzle operating concept has proven successful in practice.

The solution to the problem which has been described above with reference to a DMFC operated with methanol can also be transferred to fuel cells operated with other fuels.

The invention described herein is advantageously integrated in fuel cell systems as they are described in my copending, concurrently filed patent applications PCT/DE01/02979, PCT/DE01/02980, PCT/DE01/02910, PCT/DE01/02905, and PCT/DE01/02976, the disclosures of which are herewith incorporated by reference.

I claim:

1. A method of operating a fuel cell system having one or more stacks each with at least one fuel cell unit having an anode and a cathode, the fuel cell unit receiving a fuel during operation and discharging an anode liquid and off-gases, the method which comprises the following steps:
separating carbon dioxide formed at the anode, substantially immediately after the carbon dioxide emerges from the fuel cell stack, from the anode liquid while the anode liquid is hot, and thereby also separating out a quantity of fuel in vapor form together with the carbon dioxide;
obtaining cold water in a condenser for a cathode off-gas;
conducting the cold water in counter-current to deplete the quantity of fuel in vapor form separated out together with the carbon dioxide and thereby forming heated water; and admixing the heated water with the anode liquid.

2. The method according to claim 1, wherein the fuel is methanol and the methanol is fed as a mixture with water to a direct methanol fuel cell.

3. The method according to claim 2, which comprises measuring a methanol content with a methanol sensor in an anode circuit, and admixing the heated water before measuring the methanol content.

4. The method according to claim 3, which comprises admixing the methanol as a function of a working flow of the anode liquid in the anode circuit.

5. The method according to claim 2, which comprises determining methanol losses via a membrane between the anode and the cathode due to one of diffusion and electroosmosis by measuring a carbon dioxide concentration in the cathode off-gas, and taking the methanol losses into account in a metering in of methanol.

6. The method according to claim 2, which comprises maintaining a volume of the anode liquid at a relatively low level for achieving a rapid control response.

7. The method according to claim 2, which comprises pumping the anode liquid round as quickly as possible, for achieving a sufficient supply of methanol even at relatively low concentrations.

8. The method according to claim 2, which comprises cooling the electrode stack by evaporating water that permeates from the anode to the cathode in liquid form upon a rising temperature due to the heat of evaporation of the water at the cathode and carrying a heat content therewith.

9. The method according to claim 1, which comprises additionally condensed out water by predetermining a dew point.

10. The method according to claim 9, which comprises keeping a total water quantity constant.

11. A fuel cell installation for operation with a liquid fuel, comprising:
a fuel cell stack having at least one fuel cell with an anode part, a cathode part, and a membrane separating the anode part from the cathode part;
a fuel tank connected for supplying the liquid fuel mixed with water to the fuel cell;
a cooler for cooling an anode liquid and a CO₂ separator for separating CO₂ out of the anode liquid connected downstream of said cooler; and a rectification unit connected to said fuel cell for separating fuel off and returning the fuel into a fuel circuit of said fuel cell.

12. The fuel cell installation according to claim 11, which comprises a fuel sensor for the fuel.

13. The fuel cell installation according to claim 11, which comprises a circulation pump for returning the fuel into the fuel circuit of said fuel cell.

14. The fuel cell installation according to claim 11, which comprises a heating device connected in the fuel circuit of said fuel cell for heating the anode liquid.

15. The fuel cell installation according to claim 11, wherein said cathode part has a cathode circuit, and a condenser/cooler for water separation is connected in said cathode circuit.

16. The fuel cell installation according to claim 11, wherein said cathode part has a cathode circuit, and an expander for reducing a dew point of an off-gas is connected in said cathode circuit.

17. The fuel cell installation according to claim 16, wherein said expander is connected between a condenser/cooler and a water separator.

18. The fuel cell installation according to claim 11, wherein said cathode part has a cathode circuit, and a CO₂ sensor is connected in said cathode circuit.

19. The fuel cell installation according to claim 11, which comprises a compressor for injecting air into said cathode part of said fuel cell.

20. The fuel cell installation according to claim 11, which comprises a unit for controlling said fuel cell stack.

21. The fuel cell installation according to claim 11, which comprises a unit for regulating said fuel cell stack.

22. The fuel cell installation according to claim 11, which comprises an electrical inverter connected to said fuel cell stack.
